(19) United States
(12) Patent Application Publication
(10) Pub. No.: US 2006/0224438 A1
(43) Pub. Date: Oct. 5, 2006

(54) Method and device for providing information

(75) Inventors: Yasunari Obuchi, Fuchu (JP); Nobuo Sato, Kokubunji (JP); Akira Date, Kunitachi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/342,556

(22) Filed: Jan. 31, 2006

(30) Foreign Application Priority Data
Apr. 5, 2005 (JP) 2005-108145

(51) Int. Cl. G07G 1/00

(52) U.S. Cl. 705/10

(57) ABSTRACT

The objects of the present invention are, in connection with the provision of information mainly through images to the general public or to individuals, to detect whether the user or users who is or are at a place from where he, she or they can observe the image is or are watching the image or not and to efficiently provide good information by finding out the interest and attributes of the user or users. In order to achieve the above objects, the voice data acquired by the voice inputting unit, the image data currently being provided and information added to the image data are compared, and the degree of attention of the subjects is estimated based on the degree of similitude of these data. And the language used by the user or users is estimated by a language identifying device, and information is provided by using the language.

### CLAIM OF PRIORITY

The present application claims priority from Japanese application JP 2005-108145 filed on Apr. 5, 2005, the content of which is hereby incorporated by reference into this application.

### FIELD OF THE INVENTION

The present invention relates to a method and a device for providing information according to the taste of users mainly by images in public or private spaces and a method and a device for providing general information such as advertisement in the same way.

### BACKGROUND OF THE INVENTION

The most common means for providing information in the form of image information at public spaces such as railway stations, airports, department stores, museums or amusement parks consist of either maintaining a unilateral flow of information without regard to the will of users or allowing the users to choose expressly the information they want by operating a button.

There is, however, an attempt to acquire automatically the subject of interest or the attributes of the users and to change the information to be provided accordingly. For example, the Patent Document 1 (Japanese Patent Application Laid Open 2004-280673) discloses a method of taking the image of users with a camera and estimating the degree of interest they have by detecting the direction of their attention.
[Patent Document 1] Japanese Patent Application Laid Open 2004-280673.
[Non-patent Document 1] Bregman: “Auditory Scene Analysis: Perceptual Organization of Sound (MIT Press, 1994, ISBNO-262-521 95-4)
[Non-patent Document 2] Ueda, et al.: “IMPACT: An Interactive Natural Motion Picture Dedicated Multimedia Authoring System” (CHI91, ACM, pp. 3 43-350, 1991)
[Non-patent Document 3] Kobayashi et al.; Estimation of the Positions of a Plurality of Speakers by Free Arrangement of a Plurality of Microphones (Journal of Electronic Information Communication Society A, Vol. J82-A, No. 2. pp. 193-200, 1999)
[Non-patent Document 4] Zissman, “Comparison of four approaches to automatic language identification of telephone speech” (IEEE Transactions on Speech and Audio Processing, Vol. 4, No. 1, pp. 31-44. 1996)

### SUMMARY OF THE INVENTION

In an occasion of providing the general public or individuals with information mainly in the form of image, if it is possible to detect whether the users who are at a place allowing them to view the image are watching at the image or not, the convenience for the users can be enhanced by providing more detailed information on the subject matter being displayed at the time. And it will be possible to make the information reflect the marketing of the information provider by finding the taste of the users. In the past, the method of accepting the subjective choice of the users by installing a selecting device such as button in the information providing device has been used. However, this method is ineffective for the users who have no will strong enough to take the trouble of pressing on the button. And many of the users are not aware of the possibility of operating the information system by pressing on the button. Thus, if it is possible to detect automatically whether the users are watching the image or not and to change automatically the image displayed according to the result obtained, it will be possible to respond to the taste of a wider range of users.

The voice data obtained by the voice inputting unit, the image data now being provided and information added to the image data are compared, and the degree of attention paid by the subjects is estimated based on the degree of similitude. It is possible to estimate the degree of attention of the subjects by detecting the agreement of the dividing lines between scenes for both voice data and image data, the similitude of sound frequency patterns, and the detection of key words representing the contents of the image in the voice and other similar phenomena. And efforts will be made to provide information that is likely to be easily accepted by the users by providing the image information acquired by optimizing the information acquired from voice information by estimating the language used by the subjects by means of a language identifying device and by using the language for the information provided.

The present invention enables to provide information that will attract the interest of a larger number of users. And because of the possibility of finding more details about the taste of the users, it will be possible to collect information for bringing the sales program and the like to the taste of the users.

### BRIEF DESCRIPTION OF THE DRAWINGS

FIG. 1 is a block diagram showing an example of a system for executing various methods according to the present invention;

FIG. 2 is a schematic illustration showing an example of mode of carrying out the voice inputting unit;

FIG. 3 is a block diagram showing an example of method to analyze the correlation between voice and image;

FIG. 4 is an illustration showing an example of correlation analysis by word spotting;

FIG. 5 is an illustration showing an example of correlation analysis by scene splitting;

FIG. 6 is an illustration showing an example of correlation analysis by frequency analysis;

FIG. 7 is a flow chart showing an example of method of judging correlation;

FIG. 8 is a flow chart showing another example of method of judging correlation;

FIG. 9 is a block diagram showing an example of method of analyzing the attributes of the subjects;

FIG. 10 is a schematic illustration showing an example of mode of providing information according to the present invention;

FIG. 11 is a flow chart showing an example of dealing with the case wherein a mistake was committed in the voice image correlation analysis; and

FIG. 12 is a flow chart showing an example of dealing with the case wherein a mistake was committed in the subjects' attribute analysis.

### DETAILED DESCRIPTION OF THE PREFERRED EMBODIMENTS

We will describe in details below an embodiment of the present invention with reference to drawings.

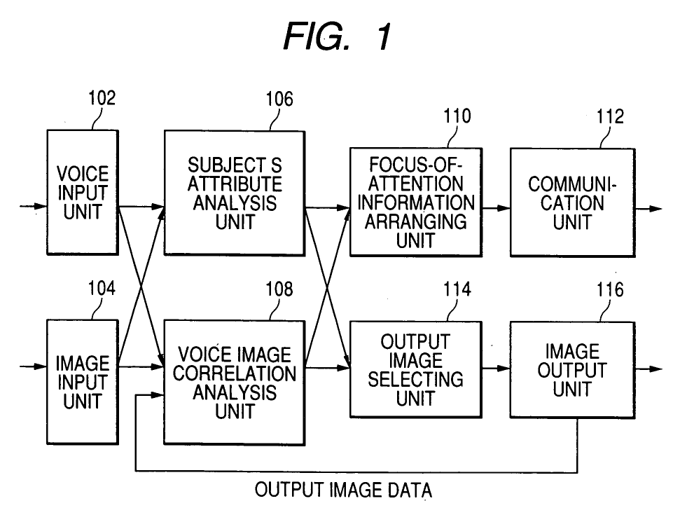

FIG. 1 is a block diagram showing the constitution of an information providing device according to the present invention. The present device is designed to be installed on the street or the like where a large number of people gather to provide them with information such as announcement or advertisement mainly in the form of image. The voice inputting unit 102 consists of a microphone and an analog-digital converter accessory thereto, collects the voice of the persons who are in the vicinity of the microphone (hereinafter referred to as “the users”) and converts the same into data in a format processable by a computer and the like. The image inputting unit 104, though not essential for carrying out the present invention, consists of a camera and a data processing device accessory thereto, and acquires information relating to the state of the users in the form of image information such as still picture and motion picture. The data thus obtained will be sent to a subjects' attribute analyzing unit 106 and a voice—image correlation analyzing unit 108.

The subjects' attribute analyzing unit estimates the language used, sex, spatial position and other attributes of the users. On the other hand, the voice and image correlation analyzing unit compares the voice data sent from the voice inputting unit with the image data sent from the image outputting unit described later to determine the correlation between them. If there is any information sent from the image inputting unit, the precision of estimating the correlation will be raised by using the information by a method described later. If the correlation between them is found to be high by the voice—image correlation analyzing unit, it is possible to estimate that the users are highly likely to be talking on a subject related to the contents of the output image, and therefore it is possible to consider that the users are interested in the current image. If the correlation is low on the contrary, it is possible that the users are not watching the image or not interested in it even if they are watching it, and that they are talking of something unrelated with the image.

The results of analyses by the subjects' attribute analyzing unit and the voice—image correlation analyzing unit will be sent to the output image selecting unit 114. Here, the following image to be outputted will be determined based on the analysis results of the preceding stage. For example, if the voice and image correlation analyzing unit finds that the image and voice are strongly correlated, the users are considered to be interested in the contents of the current image, and therefore more detailed information relating to the contents will be provided. If the correlation is weak on the contrary, the flow of the summary-type information will be continued, or the subject of the image will be changed. And if the information on the language used sent from the subjects' attribute analyzing unit is different from the language used in the sub-title of the image currently displayed, the language used in the sub-title will be changed to the language used by the users. Based on the result of selection thus obtained, the image outputting unit 116 generates the following image and displays the same on the displaying device. And the same output image data 118 as the one displayed will be sent to the voice—image correlation analyzing unit to be used in the following operation.

The analysis results of the subjects' attribute analyzing unit and the voice—image correlation analyzing unit will be sent at the same time to attention information arranging unit 110. Here, the statistical information relating to the attributes of and the degree of attention paid by the users having seen the image displayed will be arranged in order. The statistical information obtained will be provided by the communicating unit 112 to the source of distribution of the image and will be used for the elaboration of the future image distribution program.

The computing device analyzes the attributes of the subjects, analyzes the correlation between the voice and image, arranges in order the information on watchful eyes, selects the output images and performs other similar operations by executing the respective prescribed program.

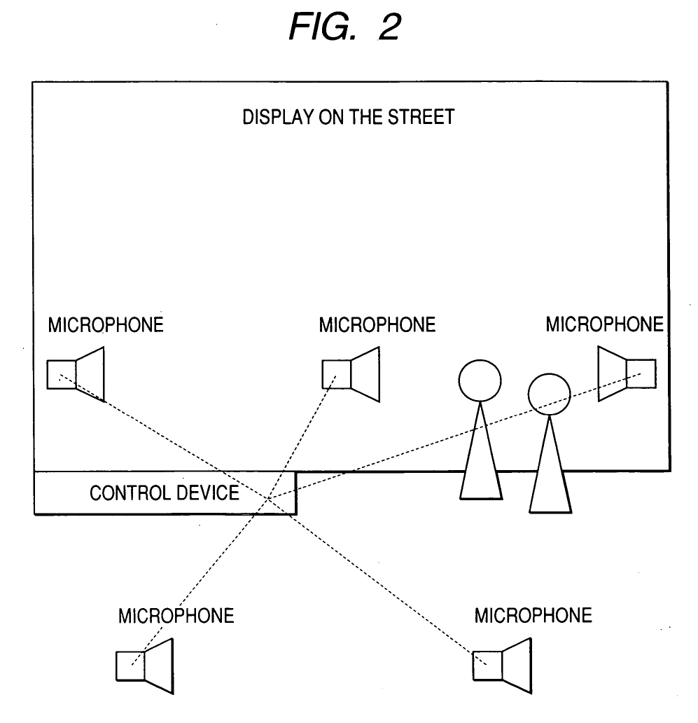

FIG. 2 is an illustration showing schematically the form of carrying out the voice inputting unit 102. If there is a display larger than a man, the man can stand at various positions when he stands in front of the display. Therefore, it will be possible to estimate the position where a user stands by installing microphones at various positions of the display, and by examining at what position the input voice to the microphone will be the maximum. And in the case of a large display, some users will be watching from a certain distance, and therefore microphones will be installed at distant positions and the signals obtained there will be sent to the controlling device. In any case, it is possible to assume that a user stands near the microphone from which the maximum signal is obtained. However, when it is desired to find out more precise position, it is possible to estimate the direction of the sound source by using signals obtained from a plurality of microphones and by the resulting phase difference. Thus, it is possible to estimate the position of the sound source by using three microphones and by way of triangulation.

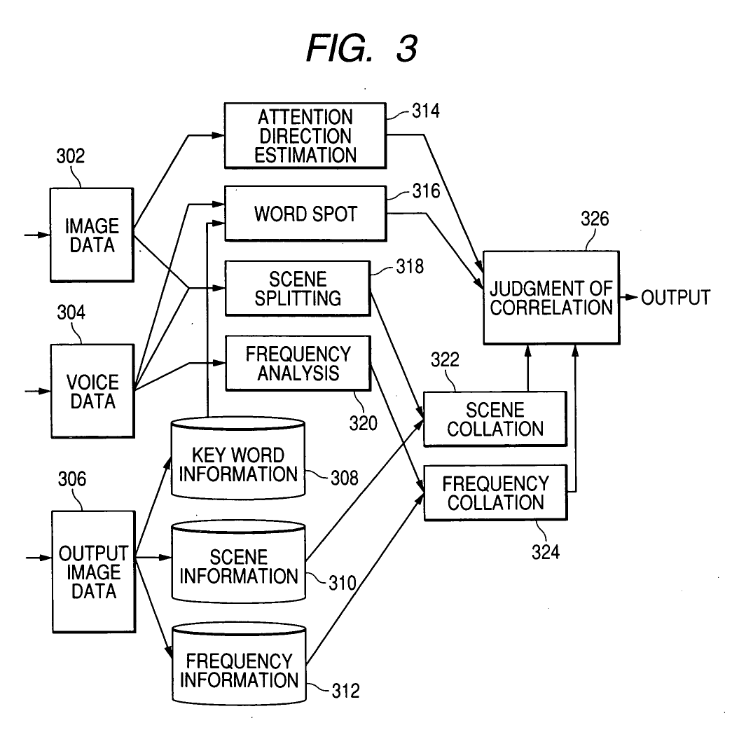

FIG. 3 is a block diagram describing the principle of operation of the voice—image correlation analyzing unit 108. The image data 302 inputted is sent to an attention direction estimating module 314, where it will be used to judge whether the users are looking in the direction of the display. It will also be sent to a scene splitting module 318. The voice data 304 inputted will be sent to a word spotting module 316, the scene-splitting module 318 and a frequency analyzing module 320.

The word spotting module 316 compares the key word information 308 that had been sent in accompaniment of the output image data 118 with the voice data and judges whether the voice data contain the key word.

The scene-splitting module 318 splits the voice data into different scenes based on information such as amplitude, spectrum and the like. The simplest method is that of judging that a scene has ended when the time during which amplitude remains below a certain fixed value has continued for more than a fixed length of time. A more sophisticated method of splitting scene can be that wherein the result of study in the field called “Auditory Scene Analysis” is applied. The scene-splitting method based on the auditory scene analysis is described in details in Bregman: “Auditory Scene Analysis: Perceptual Organization of Sound (MIT Press, 1994, ISBNO-262-5219 5-4) (Non-patent Document 1) and other similar literature.

On the other hand, the output image data 118 sent from the image outputting unit 116 is similarly split into different scenes. Generally, images output by the image outputting unit are those created in advance by devoting much time and work, and it is possible to provide information on the dividing lines between different scenes. In such a case, different scenes can be split simply by having this information read. And if scenes are not split in advance for some reasons, it is possible to split them automatically. As the method for automatically splitting images recorded on video tapes and the like into different scenes, those described in Ueda, et al.: IMPACT: An Interactive Natural Motion Picture Dedicated Multimedia Authoring System (CH I' 91, ACM, pp. 343-350, 1991) (Non-patent Document 2) and other similar literature can be used. And if image data 302 can be used, it is possible to split images into different scenes by applying similar methods to these data.

Based on the result of scene splitting in the image data, voice data and output image data thus obtained respectively, these relationships of collation will be examined by a scene collating module 322. The method of examining the relationship of collation will be described in details later on. The voice data 304 will also be sent to a frequency analyzing module 320, where various parameters of voice will be extracted. The parameters here include for example, power of the whole voice, power limited to a specific frequency zone, the fundamental frequency and the like. On the other hand, data corresponding thereto are assigned in advance to the output image data, and both of them are compared by the frequency collating module 324 to estimate correlation. The results acquired by the attention direction estimating module 314, the word spotting module 316, the scene collating module 322 and the frequency collating module 324 will be sent to the correlation judging module 326, which consolidates various results and renders the final judgment.

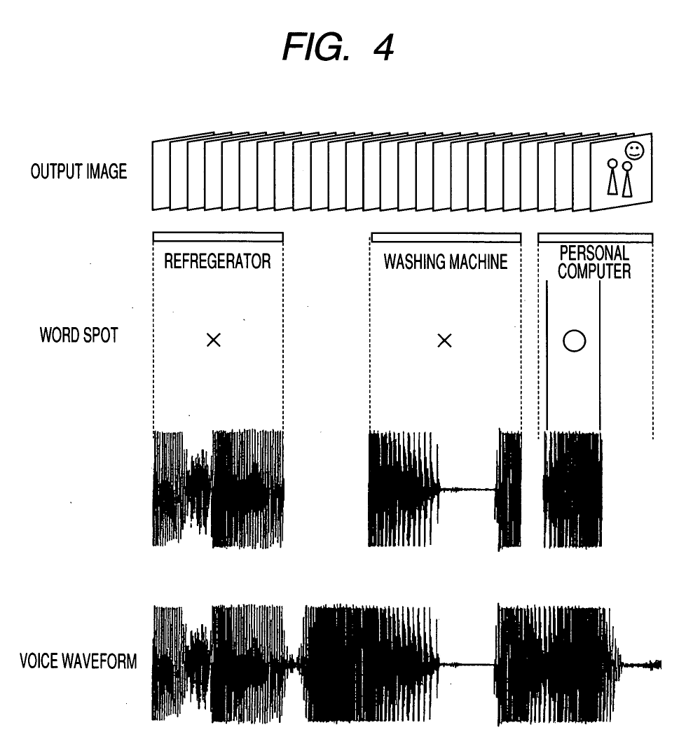

FIG. 4 is an illustration describing the details of estimating correlation by the word spotting module 316. For this method, key words are assigned in advance to images. According to the example of the figure, a key word “refrigerator” is assigned to the first part, “washing machine” is assigned to the second part and “personal computer” is assigned to the last part. The key word may be different for such small part and the same key word may be used for the whole image. In addition, the key word need not be limited to only one. At the time of execution, this key word should be used and spotted for the voice of the corresponding zone. In the illustration, the result is shown either by a circle or an X. The part wherein a key word is detected in the voice is shown by a circle and the part wherein it is not detected is shown by an X. In this example, as the key word “personal computer” is detected in the last part, it is judged highly likely that here this user may be talking while watching at the image.

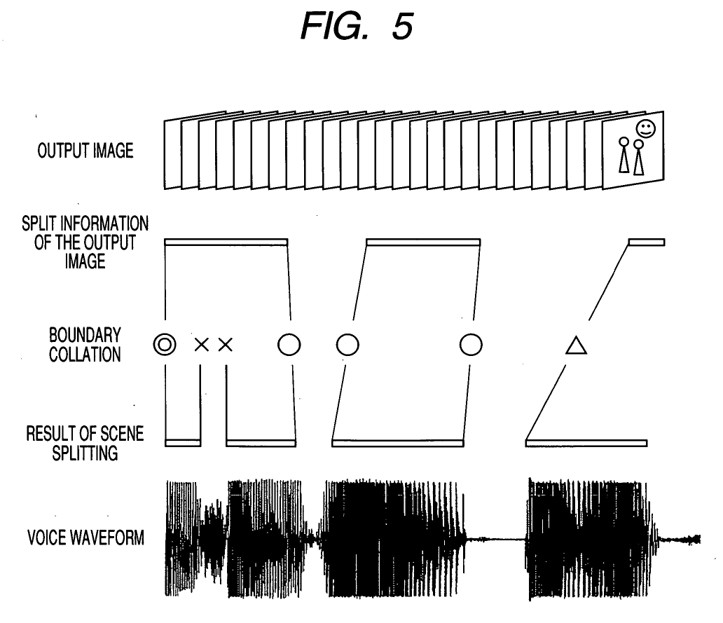

FIG. 5 is an illustration of the method of examining correlation in the scene collating module 322. The scene splitting of image data and output image data and that of voice data and output image data are compared, the scene boundaries corresponding between them are determined, and the last step of this method consists of examining how much is the time lag between them. However, at this time the scene boundary itself may not be detected on either one. In order to address to such a situation, the optimum correlation will be determined by means of dynamic programming. In the illustration, the case where the position of the corresponding scene boundary is almost equal is shown by a double circle, the case where it is near is shown by a single circle, the case where it is far away is shown by a triangle, and the case where there is no corresponding scene boundary is shown by an X. Adequate evaluation and weighting of each case and the addition of these values for all the scene boundary will enable to obtain finally the correlation value of voice data and image data.

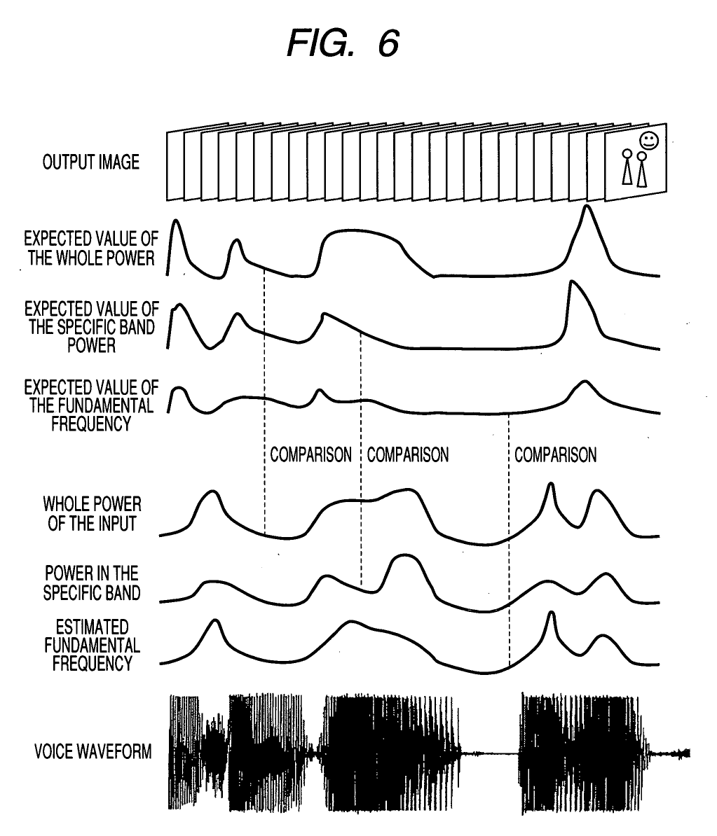

FIG. 6 is an illustration of the method of examining correlation in the frequency collating module 324. Parameters such as the whole power, the power of specific band, the fundamental frequency and the like acquired by means of frequency analysis are compared with the data such as the whole power expected value, the specific band power expected value, the fundamental frequency expected value and the like assigned in advance to the output image data and the degree of similarity is computed. It is possible to compute definitively the degree of similarity between the voice data and the image data by setting in advance the weight scale for the whole band and each specific band, and by adding each degree of similarity by using this weight scale. Incidentally, for assigning these data to the output image data, it is enough to collect only the voice data of the users who are known to be talking by watching the output image data in any unit, to analyze the frequency of these data and to average the results. And it is possible to obtain expected values by actually installing a display system according to the present invention, by collecting voice data thereby, by gathering only those data judged highly likely to be those of users who are watching the output image data among them and by making similar analyses thereby.

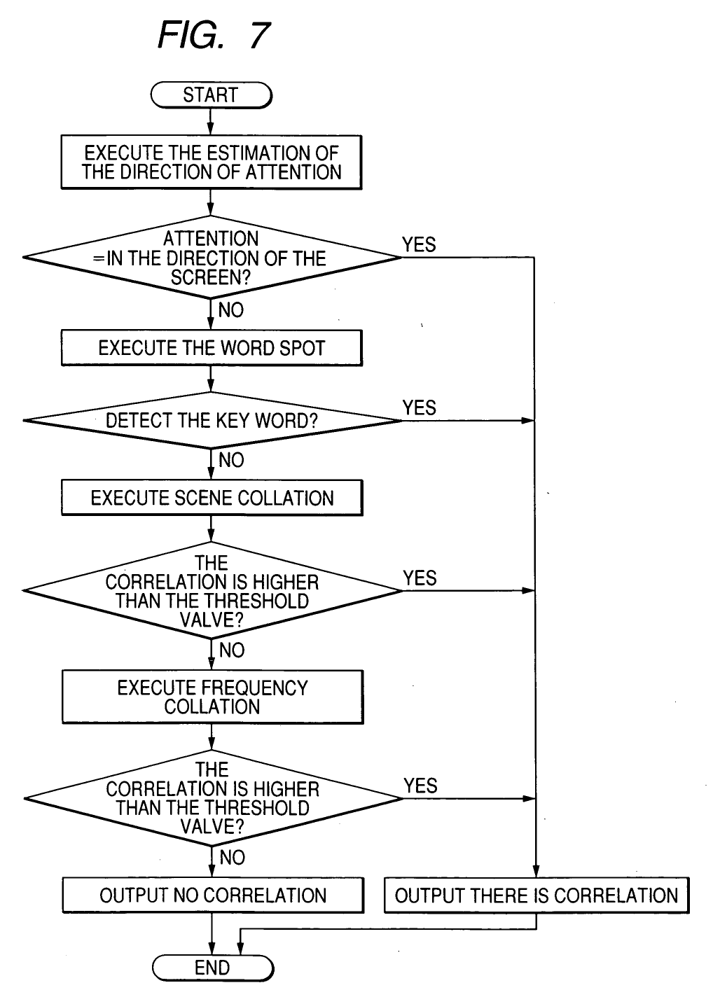

FIG. 7 is a flow chart showing an example of the operation of the correlation judging module 326. At the beginning, the direction of attention is estimated, and when the users are judged to be facing towards the screen, a judgment of “there is a correlation” is outputted and the sequence of operation is terminated. Otherwise, the process proceeds to the following step of word spotting, and when the key word is detected, a judgment of “there is a correlation” is outputted, and the sequence of operation is terminated. When a judgment of “there is correlation” is not given here either, then the scenes are collated, and when the correlation value is higher than a threshold value previously set, a judgment of “there is a correlation” is outputted and the sequence of operation is terminated. When a judgment of “no correlation” is given here again, the frequencies are collated, and if the correlation value acquired here is higher than the threshold value, a signal of “A correlation exists” is outputted, and the whole operated is terminated. When all the judgments showed “No”, a display of “no correlation” is outputted, and the whole operation is terminated.

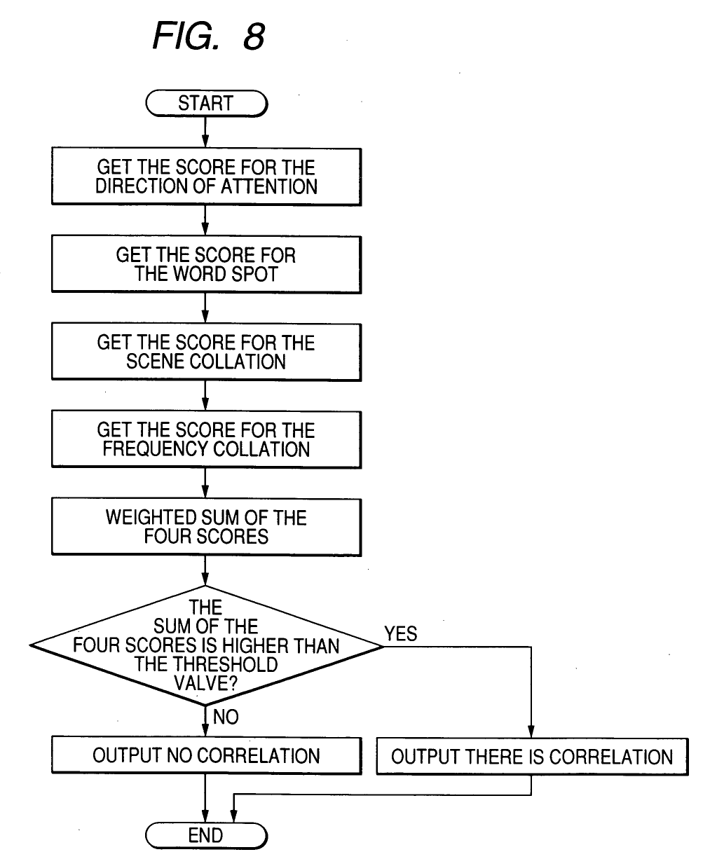

FIG. 8 is a flow chart showing another example of the correlation judging module. In this example, unlike the example shown in FIG. 7, four operations consisting of estimating the direction of attention, spotting word, collating scenes, and collating frequencies are executed irrespective of the respective mutual results. As these four operations are executed independently, they may be carried out in any order different from the order shown in the chart, and the four operations may be carried out in parallel. In their respective function, the presence or no of the correlation may be indicated by a score ranging from zero to 100 in place of a bivalent judgment of “there is a correlation or no.” Then, these four scores are weighed by the weight previously set and are totaled to make a single score for the whole. If this score is larger than the threshold value previously set, a judgment will be given that there is a correlation, and if it is smaller, it will be judged that there is no correlation, and the whole operation is terminated.

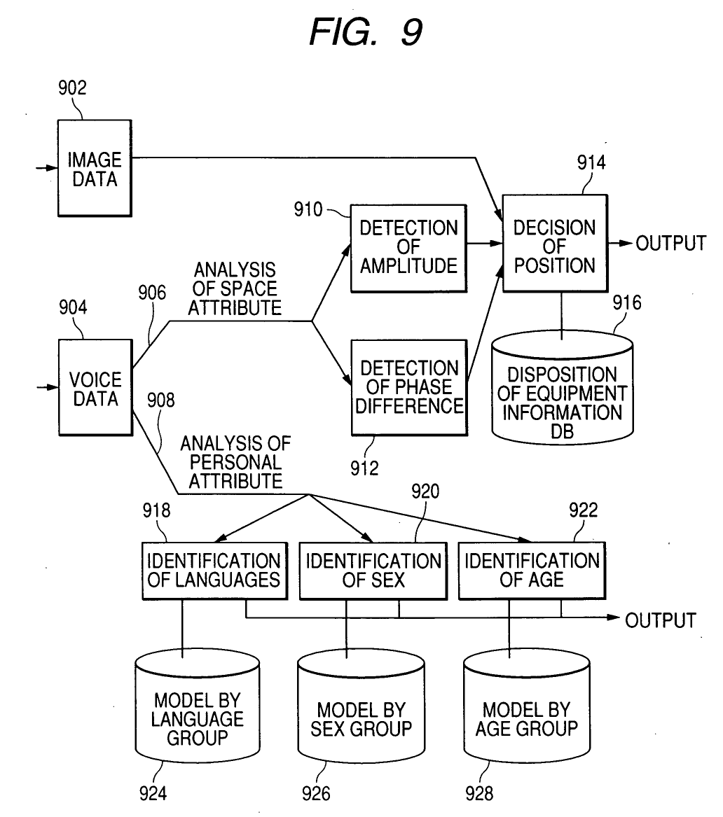

FIG. 9 is a block diagram describing in details the operation of the subjects' attribute analyzing unit 106. Based on the voice data 904 (304) inputted, analysis will be conducted along the two flows, i.e. one for the spatial attribute analysis 906 and the other for the personal attribute analysis 908.

The spatial attribute analysis will be conducted on the inputs from a plurality of microphones by two modules, i.e. the amplitude detecting module 910 and the phase difference detecting module 912, and the position judging module 914 estimates the position of users based on the result obtained thereby. At this time, reference will be made to the equipment arrangement information DB 916 showing how equipment such as microphones are actually arranged by what positional relationship. As the simplest operating method for judging position, there is for example a method of choosing the microphone showing the maximum amplitude from the results of amplitude detection by ignoring the result of detecting phase difference, and confirming the position of the microphone by the equipment arrangement information DB. A more precise method can be that of estimating the distance between various microphones and the sound source from the result of amplitude detection by taking into account the principle that the energy of sound is inversely proportional to the square of the distance from the sound source. It is also possible to estimate the direction of the sound source by detecting the phase difference of the sound that has arrived between two microphones and by comparing the wavelength of the sound. Although the values obtained by these methods are not necessarily precise due to the impacts of noises, it is possible to raise the degree of reliability by combining a plurality of estimated results. In addition, the algorithm of estimating the position of sound source by the use of a plurality of microphones is described in details in such documents as Kobayashi et al., “Estimation of the position of a plurality of speakers by the free arrangement of a plurality of microphones” (Journal of Electronic Information Communication Society A. Vol. J82 A, No. 2, pp. 193-200, 1999) (Non-patent Document 3). Incidentally, when image data 302 can be used, the determination of the position of users by directly using them can be used at the same time.

On the other hand, the personal attribute analysis leads to the acquisition of information belonging to each individual user by analyzing the features of voice. As examples of information belonging to each individual user, information such as the language used, gender, age and the like can be mentioned. These analyses can be executed by the method of comparing the language-based model 924, the sex-based model 926, and age-based model 928 previously created with the input voice in the language identification module 918, the sex identification module 920 and the age identification module 922, by computing the degree of similarity to each model, and by choosing the category with the highest degree of similarity. At the time of comparison, it is possible to raise precision by estimating at the same time the phonemic pattern included in the voice. In other words, the method consists of, at the time of recognizing voice by the generally frequently used Hidden Markov Model, using in parallel a plurality of sound models such as the Japanese sound model and the English sound model, the masculine sound model and the feminine sound model, the teen-age sound model and the persons in the twentieth sound model and the persons in the thirtieth sound model and the like for selecting the category of language, sex and age corresponding to the model acquiring the highest reliability score for the result of recognition. In order to acquire a high degree of precision in the identification of language, it is necessary to refine the method. The algorithm of language identification is described in details in such literature as Zissman: “Comparison of four approaches to automatic language identification of telephone speech” (IEEE Transactions on Speech and Audio Processing, Vol. 1.4, No. 1, pp. 31-44, 1996) (Non-patent Document 4).

We will describe below in details the operation of the output image selecting unit 116. Here, a method of presenting image for providing most efficiently information to the users is selected based on the result obtained by the subjects' attribute analyzing unit and the voice—image correlation analyzing unit. To begin with, when the language used is found as the first example, the language information included in the image will be changed to the language. And when voice is outputted in addition to image, it is possible to add the sub-title in the language used by the users provided that the language of the output voice is different from the language used by the users. Then, when the users' voice and the image are found to be strongly correlated, the users are considered to be interested in the current image, and more detailed information will be provided relating to the matters shown therein. On the contrary, when the users are not interested in the current image, the provision of only summary-type information will be continued, or images relating to some other topics will be provided. Here, if it is possible to estimate to some extent the sex and age of the user when selecting another topic, it will be possible to provide information highly likely to attract the interest of a specific class of users shown from the same.

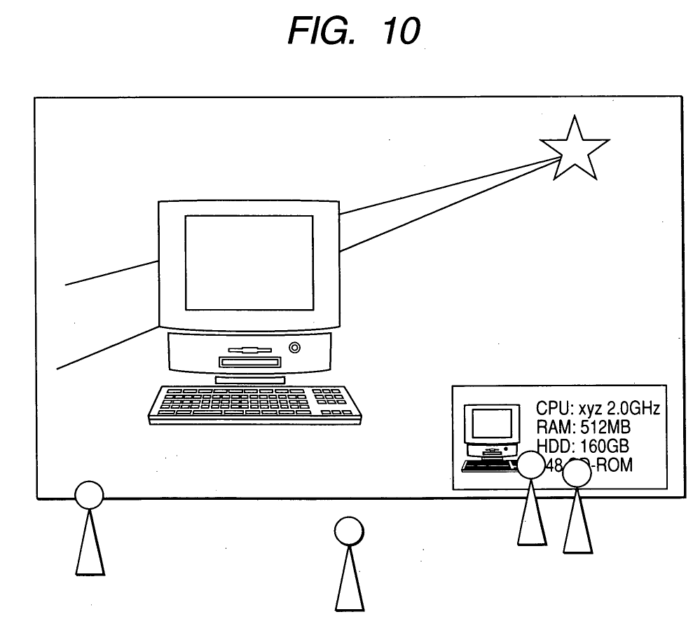

It is possible to not only select a single image displayed in this way on the whole screen but also to divide a large display and use it efficiently. FIG. 10 is an illustration showing an example of such a mode of providing information. According to this example, an image advertisement of a personal computer is shown on a remarkably large display as compared with a man. When it is judged that the users at the left side and in the middle of the display are not interested to this, but the users near the right side are likely to be interested, a small sub-window is created in the vicinity on the screen, and the detailed specifications of the product are indicated therein. In this way, detailed information can be provided to interested users and the whole image information can be provided to other users.

In order to control display image based on the degree of attention of users, it is enough to use the data stored in the storage device accessible from the output image selecting unit 114 previously correlated with the default output image as information and image data to be displayed additionally (or displayed being transformed into a default image). And in order to control display image in response to the users' attributes, it is enough to store the information and image data to be displayed additionally (or displayed being transformed into a default image) in the storage device by correlating the data with each attribute.

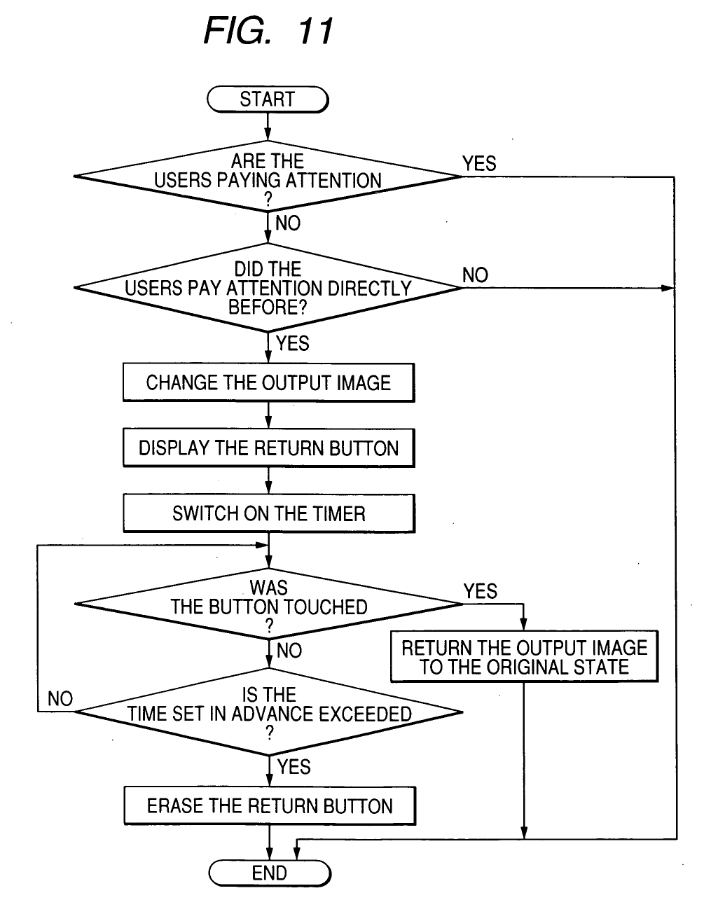

As it is expected that wrong results may be obtained always at a certain ratio in the voice—image correlation analyzing unit and the subjects attribute analyzing unit, it is desirable that there is a function of preventing the users from receiving any bad impression in such a case. FIG. 11 is a flow chart showing an example of realizing such a function. If it is judged that the users are not watching the output image, and if they are found to have been watching the same until immediately before, an image different from the previous one will be outputted. However, if this judgment is an error, the information that the user has been watching will be suddenly interrupted and the users will be displeased. Therefore, in such a case, a “Return” button will be displayed on the display screen having an input function by means of a touch panel, and when the user touches this button, the touch panel detects this action and sends out this information to the output image selecting unit 114, which then performs an operation of restoring the output image to the former state in the output image selecting unit. And this will enable to reduce the displeasure of the user. Incidentally, when this button is not touched during a certain period of time, it is considered that the erroneous judgment as described above has not been given and therefore the button will be erased. In addition, the user input device may take the form of an input device separate from the display screen in addition to the touch panel on the display screen.

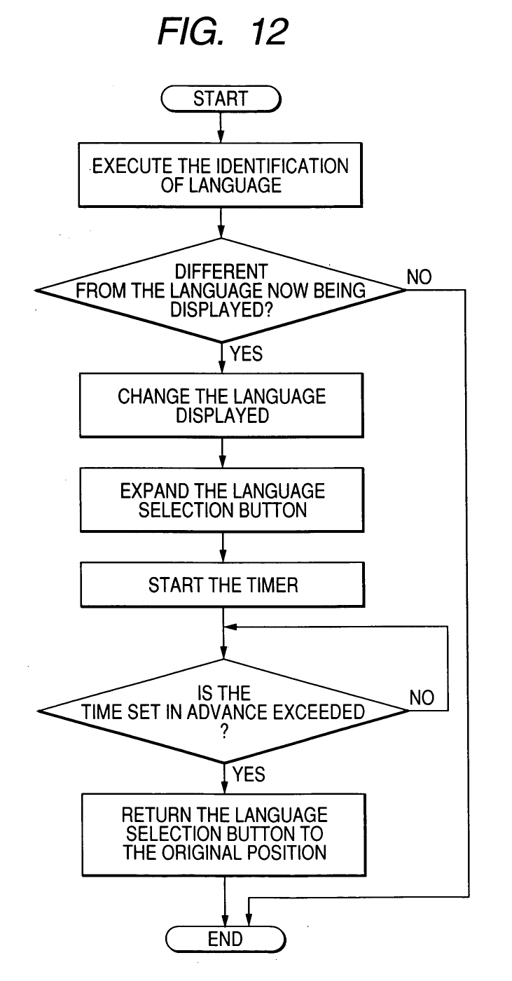

FIG. 12 is a flow chart showing a method of dealing with the case wherein an error was committed in the identification of language in the subjects' attribute analyzing unit as an example of similitude. Generally, in a language information providing system adapted to a plurality of languages, a language selection button is often provided indicating in the respective language such as [symbol] , “English” and [symbol] . And such a button is often realized as a button on the screen having a touch panel function. Therefore, in such a case, when a language different from the currently set language is detected by the identification of language, the displayed language will be changed and at the same time the size of the language selection button will be enlarged for displaying the same. In this way, the user will easily realize that the language has been automatically changed and that, if he or she is not happy with the change, the language can be changed again by operating the button. Thus, even if the user is unhappy with the automatically changed language, he or she can quickly revert to the desired language. Incidentally, as in the case of the example of FIG. 11, if this button is not touched during a fixed period of time, it will be considered that no mistaken judgment was made and the former state will be restored.

We will then describe below in details the function of the attention information arranging unit 110 and the communication unit 112. The implementation of the present invention enables to acquire information on which user showed his or her interest in which part of the displayed image. This information can be obtained by comparing the output of both the subjects' attribute analyzing unit and the voice—image correlation analyzing unit. Such information is very useful for the provider of the image. For example, when an advertisement image is displayed for the purpose of selling a product, it is possible to find out whether the user or users is or are interested in it or not, and to have the fact reflected on the future development of products. And as the value of display as an advertisement medium can be expressed numerically in details, it is possible to have the result reflected on the price of advertisement. In order to use the present system for such purpose, the attention information arranging unit extracts the information on which part of the image and how many users showed their interest, and after removing useless information from the same and arranging the same in order, the information thus obtained is sent to the Management Department through the communication unit.

The present invention can be used in devices for providing efficiently guidance information in public spaces and the like. And the present invention can also be used for improving the efficiency of providing advertisement information through images.

What is claimed is:

1. Method of providing information by images displayed on an image display device comprising:
a first step of inputting the voice of persons who are around the image display device, and
a second step of judging the degree of attention paid by said persons who are around the display device by examining the correlation in time-series changes between the image being provided and said inputted voice.

2. The method of providing information according to claim 1 comprising:
a third step of controlling the following image to be outputted based on said degree of attention.

3. The method of providing information according to claim 2, wherein a plurality of voice inputting devices installed at different positions are used to input voices in said first step and comprising:
a fourth step of estimating the position of said persons who are around the display device based on the input from said plurality of inputting devices, and wherein
images resulting from said control in the third step are displayed at the position of the display screen of said image display device corresponding to said estimated position being superposed on images other than said control result.

4. The method of providing information according to claim 2 comprising:
a fifth step of receiving the input operation to the image outputted based on said degree of attention from the input devices, and
a sixth step of controlling the following image to be outputted based on said inputting operation.

5. A device for providing information through image comprising an image displaying unit for providing information through image, a voice inputting unit for inputting the voice of the persons who are around said image displaying unit, and a computing unit for judging the degree of attention paid by said persons who are around said display device by examining the correlation in time-series changes between the image being provided and said inputted voice.

6. The device for providing information according to claim 5 wherein said computing unit controls the following image to be outputted based on said degree of attention.

7. The device for providing information according to claim 6, wherein said voice inputting unit comprises a plurality of microphones installed at different positions,
said computing unit estimates the positions of the persons who are around based on the inputs from a plurality of voice inputting devices installed at said different positions, and controls said controlled image in such a way that the same may be displayed at the position in the display screen of said image displaying unit corresponding to said estimated position being superposed with images other than said controlled images.

8. The device for providing information according to claim 6 comprising a user inputting unit for receiving operating inputs for the images outputted based on said degree of attention whereby said computing unit controls the following image to be outputted based on said operating input.

9. A device for providing information comprising an image displaying unit for providing information by image, a voice inputting unit for inputting the voices of the persons who are around said image displaying unit, and a computing unit for estimating the attributes of the speaker of the voice inputted from said voice inputted and controlling the following image to be outputted based on said estimated attribute information.

10. The device for providing information according to claim 9, comprising a unit for extracting one or more of language name, sex or age as the attributes of the speaker to be extracted from said voice inputted.
